(19) United States
(12) Patent Application Publication
(10) Pub. No.: US 2023/0417329 A1
(43) Pub. Date: Dec. 28, 2023

(54) ELECTRONIC INLET VALVE FOR AN AIR COMPRESSOR ASSEMBLY

(71) Applicant: CLARK EQUIPMENT COMPANY, Statesville, NC (US)

(72) Inventor: Marty Ball, Statesville, NC (US)

(21) Appl. No.: 18/213,743

(22) Filed: Jun. 23, 2023

Related U.S. Application Data
(60) Provisional application No. 63/355,430, filed on Jun. 24, 2022.

(51) Int. Cl. F16K 1/30; F16K 31/02; F16K 31/44

(52) U.S. Cl. CPC F16K 1/30; F16K 31/02; F16K 31/44

(57) ABSTRACT

An air compressor includes a prime mover, an air end operably connected to the prime mover, the air end configured to compress air, and an electronic inlet valve operably connected to the air end. The electronic inlet valve includes a valve body having an air inlet, a linear actuator coupled to a valve stem assembly, a valve member coupled to the valve stem assembly, a portion of the valve stem assembly is slidably received in a chamber. The chamber includes a first portion in fluid communication with a first fluid and a second portion in fluid communication with a second fluid. The linear actuator is configured to actuate the valve member through the valve stem assembly to control a flow of air to the air end, and wherein the first fluid is at a different pressure than the second fluid.

### CROSS-REFERENCE TO RELATED APPLICATIONS

This application claims priority to U.S. Provisional Patent Application No. 63/355,430, which was filed on Jun. 24, 2022 and entitled “Electronic Inlet Valve for an Air Compressor Assembly,” the contents of which is hereby incorporated by reference in its entirety.

### FIELD

This disclosure is directed toward power machines. More particularly, this disclosure is directed to an air compressor assembly that has an electronic inlet valve with a linear actuator to facilitate improved control of airflow into the air compressor.

### BACKGROUND

Power machines, for the purposes of this disclosure, include any type of machine that generates power to accomplish a particular task or a variety of tasks. One type of power machine is an air compressor. Air compressors are generally self-contained power generating devices that include a prime mover that provides a power output and a compressor that receives the power output from the prime mover and converts the power output into pressurized air. The pressurized air can, in turn, be provided to a pneumatically powered device that acts as a load on the compressor. Air compressors can be stationary (i.e., not designed to be moved once installed in a work location) or portable. Some portable compressors include a trailer that can be pulled by a vehicle from one work location to another. Other portable compressors are small enough that they can be carried to a work location.

The discussion above is merely provided for general background information and is not intended to be used as an aid in determining the scope of the claimed subject matter.

### SUMMARY

The disclosure herein is directed to an air compressor power machine. In one example of an embodiment, the air compressor includes a prime mover, an air end operably connected to the prime mover, the air end configured to compress air, and an electronic inlet valve operably connected to the air end. The electronic inlet valve includes a valve body having an air inlet, a linear actuator coupled to a valve stem assembly, a valve member coupled to the valve stem assembly, a portion of the valve stem assembly is slidably received in a chamber. The chamber includes a first portion in fluid communication with a first fluid and a second portion in fluid communication with a second fluid. The linear actuator is configured to actuate the valve member through the valve stem assembly to control a flow of air to the air end, and wherein the first fluid is at a different pressure than the second fluid.

In another example of an embodiment, an electronic inlet valve includes a valve body defining an air inlet, an air outlet, and an air channel extending between the air inlet and the air outlet, a valve stem assembly slidably received by the valve body, the valve stem assembly coupled to a valve member, a portion of the valve stem assembly slidably received by a chamber, and a linear actuator coupled to the valve stem and configured to actuate the valve stem assembly and move the valve member between a first configuration that restricts inlet air through the air inlet and a second configuration that allows inlet air through the air inlet. The electronic inlet valve is configured to be attached to an air end of an air compressor.

This Summary and the Abstract are provided to introduce a selection of concepts in a simplified form that are further described below in the Detailed Description. This Summary is not intended to identify key features or essential features of the claimed subject matter, nor are they intended to be used as an aid in determining the scope of the claimed subject matter.

### DRAWINGS

FIG. 1 is a block diagram illustrating functional systems of a representative power machine on which embodiments of the present disclosure can be advantageously practiced.

FIG. 2 is a schematic of an embodiment of a power machine in the form of a portable air compressor system.

FIG. 3 is a schematic of a portion of the portable air compressor system of FIG. 2.

FIG. 4 is a perspective view of an electronic inlet valve for the air end of the portable air compressor system of FIG. 2.

FIG. 5 is an end view of the electronic inlet valve shown of FIG. 4, taken along line 5-5 of FIG. 4 and illustrating an inlet end and associated check plate.

FIG. 6 is a cross-sectional view of the electronic inlet valve of FIG. 4, taken along line 6-6 of FIG. 5 and illustrating the electronic inlet valve in a first closed configuration.

FIG. 7 is a closeup view of a portion of the check plate in engagement with a valve seat taken along line 7-7 of FIG. 6

FIG. 8 is a cross-sectional view of the electronic inlet valve of FIG. 6, illustrating the electronic inlet valve in an open, regulated flow configuration.

FIG. 9 is a perspective cross-sectional view of the electronic inlet valve of FIG. 6 illustrating the electronic inlet valve in the first closed configuration.

FIG. 10 is a perspective cross-sectional view of the electronic inlet valve of FIG. 6 illustrating the electronic inlet valve in a second closed configuration.

FIG. 11 is a perspective cross-sectional view of the electronic inlet valve of FIG. 6 illustrating the electronic inlet valve in the open, regulated flow configuration.

### DETAILED DESCRIPTION

The concepts disclosed in this discussion are described and illustrated by referring to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

For purposes of clarity, in this Detailed Description, use of the term “fluid” shall refer to any gas or liquid unless otherwise explicitly specified. The term “parameter” shall mean any condition, level or setting for a power machine including air compressors. Examples of air compressor operating parameters include discharge pressure, discharge fluid temperature, and prime mover speed. Additionally, the terms “lubricant” and “coolant” as used herein shall mean the fluid that is supplied to a compression module and mixed with the compressible fluid during compressor operation. One preferred lubricant includes oil.

An air compressor 200 includes an electronic inlet valve 290 to an air end 228 of the air compressor 200. The electronic inlet valve 290 includes a linear actuator 416 to facilitate movement of a check plate 420. The linear actuator 416 operates in combination with vacuum generated by the air end 228 of the air compressor 200. The combination allows for a moderately sized linear actuator 416 to facilitate opening, closing, or otherwise adjusting a valve position of the electronic inlet valve 290. This provides improved control of inlet air 240 into the electronic inlet valve 290 and to the air end 228 of the air compressor 200.

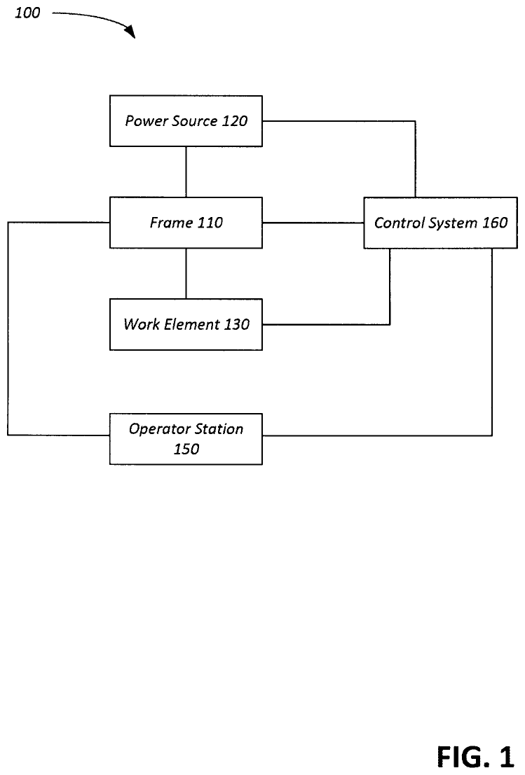

These concepts can be practiced on various power machines, as will be described below. A representative power machine on which the embodiments can be practiced is illustrated in diagram form in FIG. 1. Power machines, for the purposes of this discussion, include a frame and a power source that can provide power to a work element to accomplish a work task. One type of power machine is an air compressor. Air compressors typically include a power source that creates a compressed air output that is suitable for providing compressed air to various loads that, in turn, can perform various work tasks. Another type of power machine is a generator. Generators typically include a power source that generates an electrical output that is suitable for electrically powering various loads that, in turn, can operate in response to the electrical output.

FIG. 1 is a block diagram that illustrates the basic systems of a power machine 100, which can be any of a number of different types of power machines, upon which the embodiments discussed below can be advantageously incorporated. The block diagram of FIG. 1 identifies various systems on power machine 100 and the relationship between various components and systems. As mentioned above, at the most basic level, power machines for the purposes of this discussion include a frame and a power source that can be coupled to a work element. The power machine 100 has a frame 110, a power source 120, and an interface to a work element 130.

Some representative power machines may have one or more work elements resident on the frame 110, including, in some instances a traction system for moving the power machine under its own power. However, it is not necessary or even uncommon for a representative power machine on which the inventive elements discussed below may be advantageously practiced to not have a traction system or indeed any onboard work element. For the purposes of this discussion, any load on the compressor should be considered a work element, even if it doesn't perform work in the classic sense of providing energy to move an object over a distance. Power machine 100 has an operator station 150 that provides access to one or more operator-controlled inputs for controlling various functions on the power machine. These operator inputs are in communication with a control system 160, which can include a controller. The control system 160 is provided to interact with the other systems to perform various tasks related to the operation of the power machine at least in part in response to control signals provided by an operator through the one or more operator inputs. The operator station 150 can also include one or more outputs for providing a power source that is couplable to an external load. Frame 110 includes a physical structure that can support various other components that are attached thereto or positioned thereon. The frame 110 can include any number of individual components.

Frame 110 supports the power source 120, which is configured to provide power to one or more work elements 130 that may be coupled to or integrated with the power machine 100. Power sources for power machines typically include an engine such as an internal combustion engine and a power conversion system such as a compressor that is configured to convert the output from an engine into a form of power (i.e., compressed air) that is usable by a work element.

FIG. 1 shows a single work element designated as work element 130, but various power machines can have any number of work elements. Work elements are operably coupled to the power source of the power machine to perform a work task.

Work elements can be removably coupled to the power machine to perform any number of work tasks. For the purposes of this example, work element 130 can be an integrated work element or a work element that is not integrated into the power machine, but merely couplable to the power machine.

Operator station 150 includes an operating position from which an operator can control operation of the power machine by accessing user inputs. Such user inputs can be manipulated by an operator to control the power machine by, for example, starting an engine, setting an air pressure level or configuration, and the like. In addition, the operator station 150 can include outputs such as ports to which external loads can be attached. In some power machines, the user inputs and outputs are located in the same general area, but that need not be the case. An operator station 150 can include an input/output panel that is in communication with the controller of control system 160.

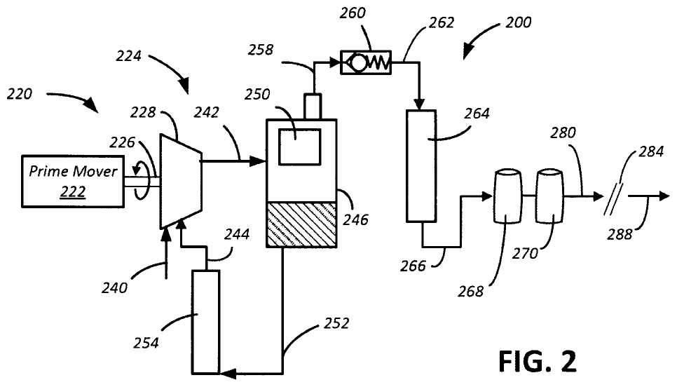

FIG. 2 is a schematic diagram illustrating an embodiment and associated components of an air compressor discharge system 200. Air compressor discharge system 200 (or more briefly, air compressor 200) is configured to generate and discharge a compressed gas such as air to an output and to any work element coupled to the air compressor 200 via an output. Air compressor 200 has a power source 220, which includes a prime mover 222 and a power conversion system 224 to convert power from the prime mover 222 into a form (i.e., compressed gas) that can be used by work elements. As shown in FIG. 2, the prime mover 222 is an internal combustion engine, although other types of prime movers (such as an electric motor) may be used without departing from the scope of this discussion.

An output shaft 226 is coupled to an air end 228, which is operable to receive a supply of gas at an inlet 240 and provide compressed gas at an outlet 242. The air end 228 can be of any suitable style, including a variable speed, oil-flooded rotary screw type air end. In an oil-flooded compressor, oil flows between rotating screws of the air end to lubricate and enhance the seal between the screws. Some of the oil invariably mixes with the compressed gas and is discharged through the outlet 242 as a mixed compressed gas-oil flow. Oil is introduced into the air end 228 at input 244 and expelled from the air end along with compressed gas at outlet 242.

The compressed gas-oil mixture is introduced into a separator tank 246. The separator tank 246 may perform a mechanical separation step to separate some of the oil from the compressed gas-oil mixture (also referred to as an air-oil mixture). In addition, the separator tank 246 includes a separator element 250 (e.g., a filter) that separates additional oil from the air-oil stream that has passed through the outlet 242 and into the separator tank 246. The separator tank 246 includes an outlet 252 coupled to the separator tank 246 and to an oil cooler 254. Oil is passed from the separator tank 246 through the outlet 250 to the oil cooler 50, where the oil is cooled. Cooled oil is passed from the oil cooler 254 through the outlet 54 to the air end 228, where the cooled oil is reintroduced into the air end 228 to lubricate and enhance the seal between the screws. The separator tank 246 can also be referred to as an oil separator 246.

With continued reference to FIG. 2, the system 200 also includes an outlet 258 coupled to both the separator tank 246 and to a minimum pressure check valve 260. Air passes from the oil separator tank 246 through the outlet 258 to the check valve 260. The check valve 260 is normally closed and is biased toward a closed position with a spring or other biasing element. The check valve 260 only opens when the pressure of the compressed air passing through the outlet 258 (in the direction illustrated by the arrow in FIG. 1) is large enough to overcome the force of the spring or other biasing element. The check valve 260 inhibits or prevents air or other material from reversing its flow direction and entering the separator tank 246, oil cooler 254, and air end 228 from the downstream side of the system. Of course, the check valve 260 can be positioned at other points within the flow path if desired.

With continued reference to FIG. 2, the system 200 also includes an outlet 262 coupled to the check valve 260 and to an aftercooler 264. Substantially oil-free compressed air is passed from the separator tank 246 through the outlet 258, the check valve 260, and the outlet 262 to the aftercooler 264. The aftercooler 264 is a heat exchanger that cools and removes heat produced during compression from the air. As the air cools, it approaches its dew point and moisture begins to condense out of the air.

Some air compressor systems do not include an aftercooler.

The aftercooler 264 has an outlet 266 that is coupled to a water separator 268 via a line. Air is passed from the aftercooler 264 through the outlet 266 to the water separator 268. The water separator 268 is coupled to an oil removal filter 270. The water separator 268 and the oil removal filter 270 remove water and oil from the air, respectively. Air passes through the water separator 268 prior to passing through the oil removal filter 270. The order of the water separator 268 and the oil removal filter 270 can be reversed. Air is then discharged through an outlet 280. The outlet 280 includes at least one customer connection point 284. In some embodiments, the outlet 280 can be in fluid communication with a plurality of customer connection points 284 (e.g., by a manifold, etc.). In other embodiments, the outlet 280 can be in fluid communication with a single customer connection point 284. A customer service line 288 is configured to removably couple to each customer connection point 284. Each customer connection point 284 can be any suitable connector or coupling to facilitate a removably connection with the customer service line 288. An example of a suitable customer connection point 284 can be a hose connector or other suitable structure. Each customer service line 288 can facilitate a fluid connection to a point of use of compressed air, which can include, but is not limited to, a pneumatic tool, a pump, equipment requiring compressed air, control systems and/or actuators requiring compressed air, etc.

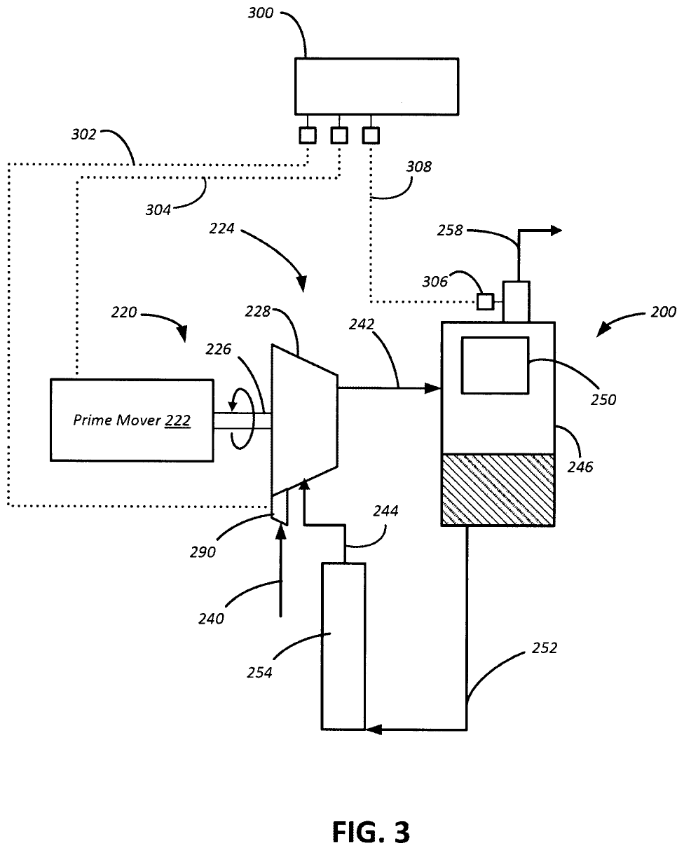

FIG. 3 is a portion of the schematic diagram of FIG. 2. FIG. 3 illustrates a portion of the air compressor 200, notably the components upstream of the outlet 258 of the oil separator tank 246. The air end 228 includes an inlet valve 290. The inlet valve 290 receives the supply of gas, illustrated as inlet gas 240, and more specifically a supply of air at atmospheric pressure. The inlet valve 290 is configured to open and/or close to selectively control an inlet flow of air to the air end 228. The inlet valve 290 is an electronic inlet valve 290. More specifically, the valve element of the electronic inlet valve 290 is electronically controlled. The electronic inlet valve 290 is unique to air compressors in the art, as valve elements of inlet valves for known air ends are generally pneumatically controlled. Known pneumatic valves are substantially slower in response to controls than the electronic inlet valve 290. In addition, the electronic inlet valve 290 advantageously has more precise control to regulate air flow into the air end 228 than known pneumatic valves.

A control system 300 (also referred to as a controller unit 300 or a controller 300 or an electronic control unit 300) is in operable communication with the electronic inlet valve 290 by a data connection 302 (also referred to as a first data connection 302 or a first communication connection 302). The data connection 302 is configured to facilitate communication between the electronic inlet valve 290 and the control system 300. For example, the data connection 302 can communicate a valve position of the electronic inlet valve 290 to the control system 300, such as through a position sensor. In addition, the data connection 302 can communicate operational instructions from the control system 300 to the electronic inlet valve 290, such as a target valve position.

Data connection 302 is shown as a discrete communication line between the control system 300 and the electric inlet valve 290. In some embodiments, data connection 302 (and some or all of the data communications 304-308 discussed below can be implemented as part of a pre-defined serial communication bus such as the well-known-in-the-art Controller Area Network (also known as a CAN bus). One of ordinary skill in the art will appreciate that devices that are in communication with a CAN bus (which in some embodiments include controller 300 and/or electric inlet valve 290) are configured to be capable of communicating on a CAN bus.

The control system 300 is also in operable communication with the prime mover 222 by a data connection 304 (also referred to as a second data connection 304 or a second communication connection 304, which can be implemented in some embodiments via a CAB bus as discussed above). The data connection 304 is configured to facilitate communication between the prime mover 222 and the control system 300. For example, the data connection 304 can communicate an operating speed (also referred to as a working speed or an engine speed) of the prime mover 222 to the control system 300. The operating speed is generally communicated in revolutions per minute (or RPM). In addition, the data connection 304 can communicate operational instructions from the control system 300 to the prime mover 222, such as a target operating speed (also referred to as a target working speed or a target engine speed). It should be appreciated that the control system 300 can be in operable communication with a prime mover controller (not shown) (also referred to as an engine controller), which is configured to control operation of the prime mover 222. In other embodiments, the control system 300 can integrate the prime mover controller.

The control system 300 is in operable communication with an operating pressure sensor 306 by a data connection 308 (also referred to as a third data connection 308 or a third communication connection 308, which can be implemented in some embodiments via a CAN bus as discussed above). The data connection 308 is configured to facilitate communication between the operating pressure sensor 306 and the control system 300. For example, the data connection 308 can communicate an operating pressure of the air compressor 200. The operating pressure is generally communicated in pounds per square inch (or PSI). The operating pressure sensor 306 is operably connected to the separator tank 246. The operating pressure sensor 306 (also referred to as a pressure sensor 306) is any suitable sensor configured to measure (or detect) a pressure (or operating pressure) of the air compressor 200. While illustrated as operably connected to the separator tank 246 (and thus measuring an operating pressure in the separator tank 246, it should be appreciated that the operating pressure sensor 306 can be positioned at any suitable position to detect a pressure representative of the operating pressure of the air compressor 200. For example, the operating pressure sensor 306 can be positioned at a suitable position downstream of the separator tank 246, such as in the outlet 258 of the separator tank 246 or the outlet 280 upstream of the customer connection point 284.

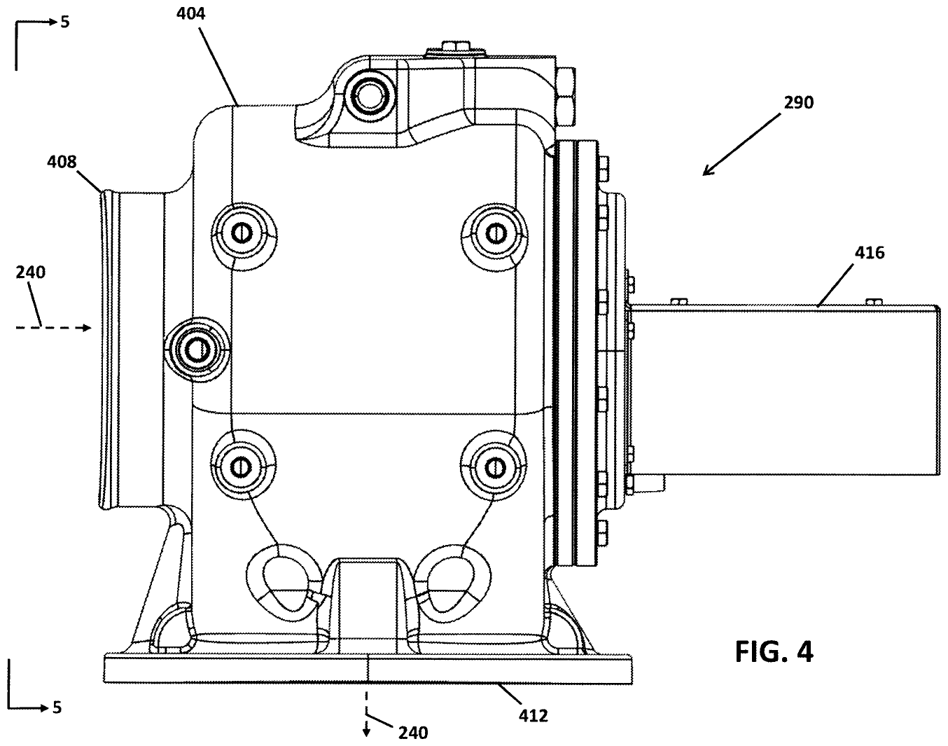

FIG. 4 is a perspective view of the electronic inlet valve 290, shown detached from the air end 228 according to one illustrative embodiment. The electronic inlet valve 290, which can also be referred to as an electronic inlet valve assembly 290, includes a valve body 404 (also referred to as a housing 404 or a valve housing 404). The valve body 404 defines an air inlet 408 and an air outlet 412 each of which includes an aperture into or from which air can travel. In the illustrated embodiment, the air inlet 408 and the air outlet 412 are oriented generally orthogonal (or perpendicular) to each other.

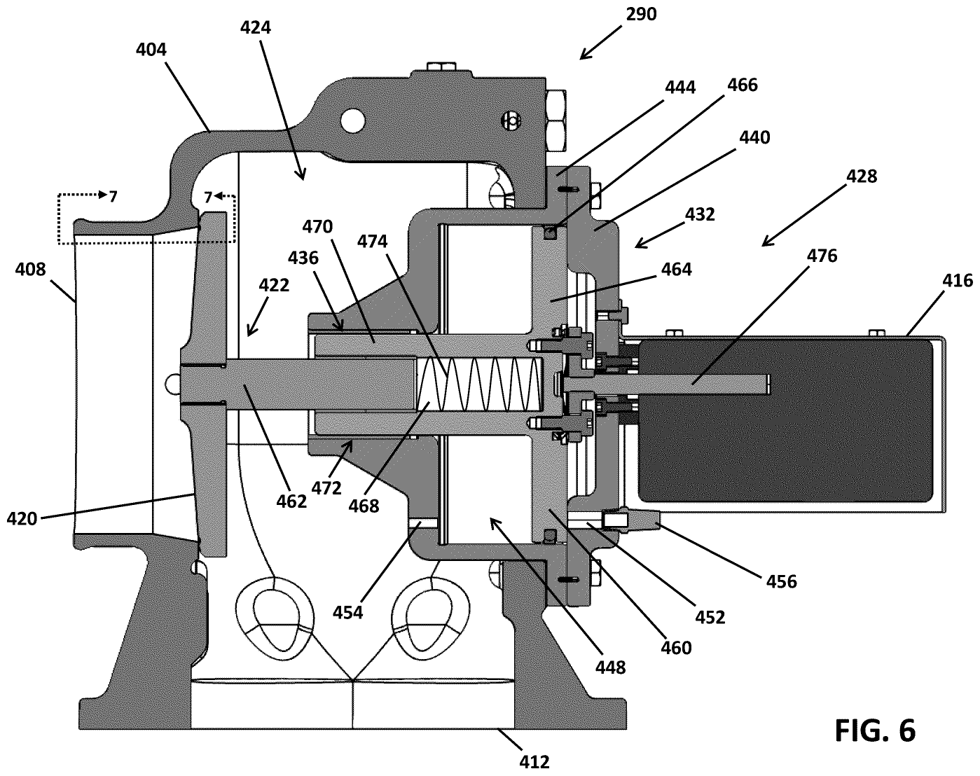

In other examples of embodiments, the air inlet 408 and the air outlet 412 can be oriented at an oblique angle (or obliquely) to each other. Unless otherwise discussed herein, the exact angle between the orientation of the inlet in various embodiments can vary without departing from the scope of this discussion. The inlet gas 240 (also referred to as inlet air 240) enters the valve body 404 through the air inlet 408 and into a cavity 424—see FIG. 6—located within the valve body unless the air inlet is blocked as will be discussed in more detail below. Though not shown, the air inlet 408 can be coupled (or fluidly connected) to an air filter configured to filter inlet air 240 prior to entering the valve body 404 of the electronic inlet valve 290. The air outlet 412 is provided to allow air to exit the cavity 424 and travel to the air end 228 (shown in FIG. 3). It should be appreciated that a vacuum generated by operation of the air end 228 (i.e., rotation of rotary screws within the air end in the case of a rotary screw compressor) draws the inlet air 240 into the air inlet 408, through the valve body 404, and out of the electronic inlet valve 290 through the air outlet 412. A linear actuator 416 is fastened to the valve body 404 on a side (or end) opposite the air inlet 408. Linear actuator 416 is provided to control a valve element internal to the housing 404 to selectively control whether and how much air is provided to the air end 228 through the inlet valve 290.

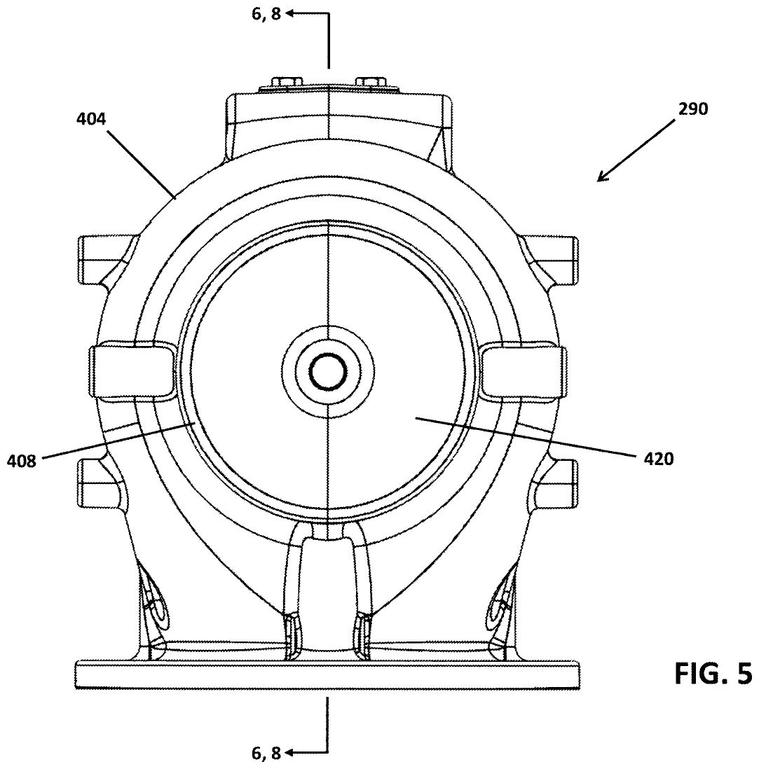

FIG. 5 is a first end view the electronic inlet valve 290, illustrating the air inlet 408. A check plate 420 is positioned within the valve body 404. The check plate 420 is configured to move (or slide) within the valve body 404. More specifically, the check plate 420 is configured to operated as a valve element that selectively moves between a fully open and a fully closed position to allow up to a maximum flow, up to a restricted flow that is less than the maximum flow, or no flow, respectively, into the air inlet 408. As such, the check plate 420 is configured to control a flow of inlet air 240 entering into (or through) the electronic inlet valve 290 via the air inlet 408. The check plate 420 is configured to move in response to actuation by the linear actuator 416. Accordingly, in other embodiments of the electronic inlet valve 290, the linear actuator 416 can be coupled to the valve body 404 at any position relative to the air inlet 408 suitable for movement of the check plate 420. The check plate 420 can also be referred to as a valve member 420 or a disc 420 or a plug 420.

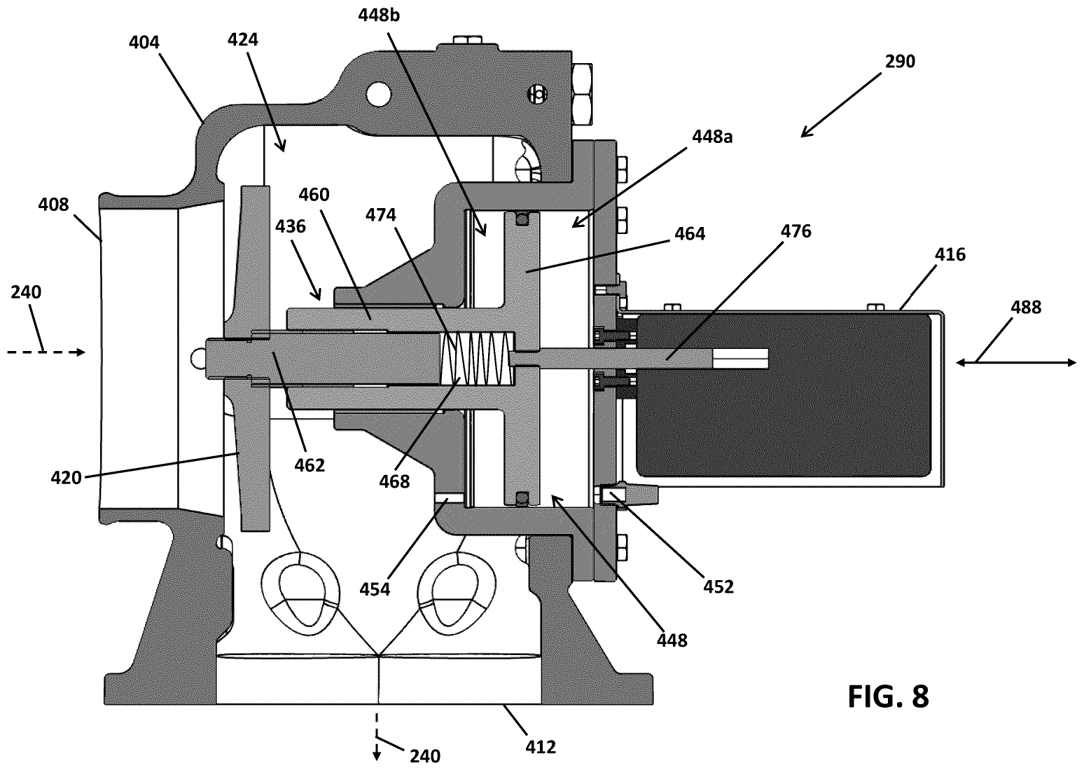

FIG. 6 illustrates a cross-sectional view of the electronic inlet valve 290. As discussed above, the valve body 404 defines a channel or cavity 424 that extends between the air inlet 408 and the air outlet 412. The check plate 420 is configured to slide within a portion of the air channel 424 and in line with the inlet 408. To facilitate sliding movement of the check plate 420, the check plate 420 is operably coupled to a position adjustment assembly 428 (also referred to as a slide assembly 428). The position adjustment assembly 428 includes the linear actuator 416, a bonnet assembly 432, a valve stem assembly 436, and the check plate 420. The linear actuator 416 is configured to slide the valve stem assembly 436 relative to the bonnet assembly 432, and in response actuate the check plate 420 relative to the valve body 404 between a closed position (shown in FIG. 6), a completely open position (not shown), and a plurality of partially open positions therebetween (one such partially open position is shown in FIG. 8). In some embodiments, the position of the check plate is infinitely variable between the closed position and the completely open position.

With continued reference to FIG. 6, the bonnet assembly 432 includes a first housing member 440 and a second housing member 444. The first and second housing members 440, 444 are assembled together using fasteners or other suitable coupling configurations. In addition, the first and second housing members 440, 444 are secured to the valve body 404 using fasteners or other suitable coupling configurations. In the illustrated embodiment, the second housing member 444 is partially received by the valve body 404 such that it extends into the air channel 424. The first housing member 440 is fastened to the second housing member 444 and positioned between the second housing member 444 and the linear actuator 416. In alternative embodiments, the first and second housing members 440, 444 and the valve body 404 can be constructed differently than is shown in FIG. 6. For example, second housing member 444 can be integrated into valve body 404. Other combinations of these components can be used without departing from the scope of this discussion.

The bonnet assembly 432 defines a chamber 448 between the first housing member 440 and the second housing member 444 when the first and second housing members are assembled together. More specifically, the first and second housing members 440, 444 cooperate to define the chamber 448. A first port 452 extends through the first housing member 440 to the chamber 448. A second port 454 extends through the second housing member 444 to the chamber 448. In the illustrated embodiment, the first port 452 is exposed to the atmosphere (or air at atmospheric pressure or to a fluid source outside of the valve body 404). Thus, the first port 452 fluidly connects the chamber 448 to a first air source. The second port 454 is exposed to the air channel 424. During operation of an attached air end 228, the second port 454 contains air under vacuum. Accordingly, the second port 454 fluidly connects the chamber 448 to a second air source. The second air source (or second fluid source) is different than the first air source (or first fluid source). More specifically, the second air source has a pressure that is different than the first air source. In response to operation of the air end 228, the second air source is air under vacuum. Accordingly, the second air source is at a lower air pressure than the first air source, which is air at atmospheric pressure. Accordingly, the chamber 448 is configured to have a portion that contains air from the first air source and a portion that contains air from the second air source, the air sources having a different air pressure. In the illustrated embodiment, a first portion 448a of the chamber 448 (shown in FIG. 8) contains air at atmospheric air pressure and a second portion 448b of the chamber 448 (also shown in FIG. 8) contains air at an air pressure that is less than atmospheric air pressure. In other embodiments, the first portion 448a of the chamber 448 can contain air that is above atmospheric pressure, or air that is below atmospheric pressure. In these embodiments, the first portion 448a of the chamber 448 contains air that is at an air pressure that is different than the air pressure of the contained in the second portion 448b of the chamber 448. The first port 452 can include an air filter 456 configured to filter air entering the chamber 448, and specifically the first portion of the chamber 448. It should also be appreciated that while the second port 454 is shown as generally horizontal, the second port 454 (or a portion thereof) can be sloped from the chamber 448 towards the air outlet 412 to facilitate draining of potential condensate that may build up in the second port 454 and/or in the chamber 448.

The valve stem assembly 436 is positioned in the chamber 448. More specifically, a portion of the valve stem assembly 436 is received by the chamber 448 and configured to slide within the chamber 448. Another portion of the valve stem assembly 436 extends through the second housing member 444 and into the air channel 424 where it couples to the check plate 420. The valve stem assembly 436 includes a first stem member 460 (also referred to as a first member 460 or a piston member 460) and a second stem member 462 (also referred to as a second member 462 or a shaft member 462).

The first stem member 460 includes a piston 464. The piston 464 is sized to correspond with a size of the chamber 448. As such, the first stem member 460 and associated piston 464 are configured to slide within the chamber 448. The piston 464 is also configured to act as a barrier between the first and second portions of the chamber 448. Thus, the piston 464 is configured to separate (or selectively seal) the first portion 448a from the second portion 448b of the chamber 448 (shown in FIG. 8) such that the first air source is positioned on a first side of the piston 464 and the second air source is positioned on a second side of the piston 464. The second side of the piston 464 is opposite the first side of the piston 464. To facilitate the seal, the piston 464 can include a gasket member 466. In the illustrated embodiment, the gasket member 466 (also referred to as a gasket 466) extends around a circumference of the piston 464. The gasket member 466 can be received in a gasket channel or otherwise couple to the piston 464 is any known or suitable fashion to facilitate retention of the gasket member 466 as the piston 464 laterally traverses (or slides) within the chamber 448.

The first stem member 460 also defines a channel 468. A body portion 470 of the first stem member 460 extends away from the piston 464. In the illustrated embodiment, the body portion 470 is oriented perpendicular to the piston 464. The body portion 470 extends through an aperture 472 in the second housing member 444. More specifically, the body portion 470 is received by the aperture 472 in the second housing member 444. The body portion 470 is also configured to slide relative to the second housing member 444. Thus, the first stem member 460 is configured to slide relative to the bonnet assembly 432, and more specifically relative to the second housing member 444. The first stem member 460 is also configured to extend through the bonnet assembly 432 into the air channel 424. The body portion 470 defines the channel 468. The first stem portion 460, which includes the piston 464, the body portion 470, and the channel 468 defined by the body portion 470, can also be referred to as a vacuum balance piston 460.

The second stem member 462 is received by the first stem member 460. More specifically, the second stem member 462 is slidably received by the first stem member 460. A portion of the second stem member 462 is received in the channel 468. A biasing member 474 is received (or positioned) in the channel 468. The biasing member 474 is positioned between the first stem member 460 and the second stem member 462. Thus, as the second stem member 462 slides within the channel 468 relative to the first stem member 460, the second stem member 462 is configured to engage the biasing member 474. The biasing member 474 can be any suitable spring or spring like device configured to apply a biasing force onto the second stem member 462.

The check plate 420 is coupled to the valve stem assembly 436. As such, the check plate 420 is configured to slide with the valve stem assembly 436 as it moves (or slides) relative to the bonnet assembly 432. More specifically, the check plate 420 is coupled to the second stem member 462. The check plate 420 is configured to move with the second stem member 462 relative bonnet assembly 432, and more specifically relative to the to the second housing member 444 of the bonnet assembly 432. The check plate 420 is also configured to move with the second stem member 462 relative to the first stem member 460. The check plate 420, and the attached second stem member 462, can also be referred to as a check valve plate 422. The check valve plate 422 and the vacuum balance piston 460 together form the valve stem assembly 436.

The linear actuator 416 is coupled to the valve stem assembly 436. More specifically, the linear actuator 416 is coupled (or fastened) to the piston 464. In the illustrated embodiment, an arm 476 of the linear actuator 416 is coupled (or fastened) to the valve stem assembly 436. The linear actuator 416 is configured to move (or slide) the valve stem assembly 436 relative to the bonnet assembly 432. As shown in FIG. 6, the arm 476 of the linear actuator extends through an aperture in the bonnet assembly 432, and more specifically through an aperture in the first housing member 440. The arm 476 is coupled (or fastened) to the first stem member 460. More specifically, the arm 476 is coupled (or fastened) to the piston 464 of the first stem member 460.

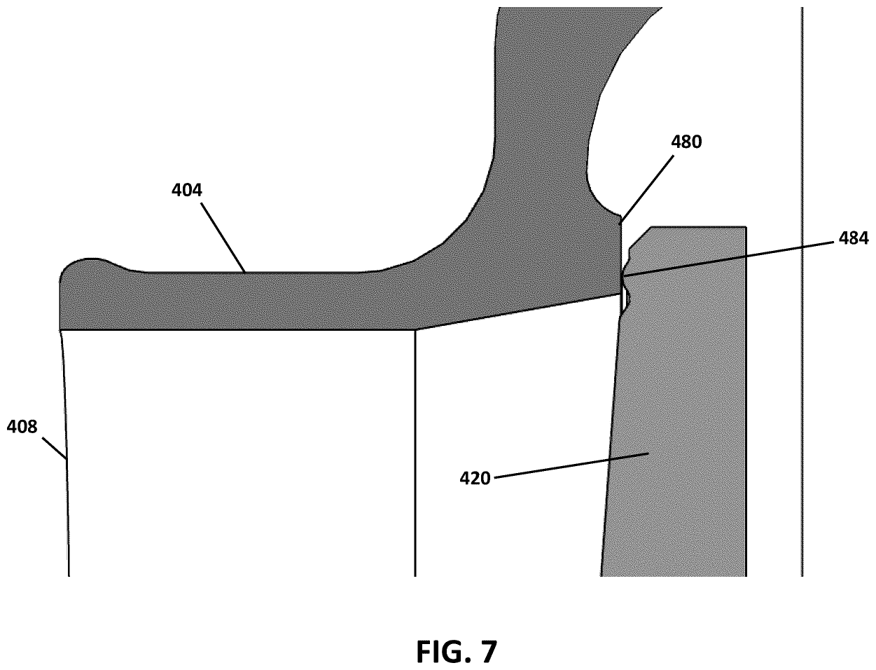

With reference to FIG. 6, the electronic inlet valve 290 is shown in a shutdown state. In this state, the check plate 420 is in a closed configuration. With reference now to FIG. 7, when in a closed configuration, the check plate 420 is configured to engage the valve body 404. More specifically, a portion of the check plate 420 is configured to engage (or is in engagement with) a portion of the valve body 404. In the illustrated embodiment, the check plate 420 is in engagement with a valve seat 480 that is defined by the valve body 404. To improve a seal between the check plate 420 and the valve seat 480 when in the check plate 420 is in the closed configuration, the check plate 420 can include a sealing surface 484. The sealing surface 484 is illustrated in FIG. 7 in one embodiment as a raised convex section (or other raised geometric shape) of the check plate 420 that is configured to be seated on the valve seat 480. The sealing surface 484 can be made of and integral to (i.e., formed on) the valve plate 420. In the illustrated embodiment, the sealing surface 484 is approximately 0.50 mm, has approximately a 1.0 mm diameter, and is configured to engage the valve seat 480. The sealing surface 484 extends around the check plate 420 to engage the valve seat 480 around the air inlet 408. In other embodiments, the sealing surface 484 can be on the valve seat 480 (i.e., on a portion of the valve body 404 as opposed to on the check plate 420) that is configured to engage a portion of the check plate 420. In yet other examples of embodiments, the sealing surface 484 can be a tapered portion of the check plate 420 and/or valve seat 480. In other examples of embodiments, the sealing surface 484 can various other surface formations on the check plate 420 that is configured to engage a complementary surface of the valve seat 480. Alternatively, the sealing surface 484 can be a gasket or rubber seal that can be attached to the check plate 420, attached to the valve seat 480, or a plurality of sealing surfaces 484 respectively attached to both the check plate 420 and the valve seat 480. In yet other examples of embodiments, any suitable sealing system can be implemented to facilitate an improved seal between the check plate 420 and the valve body 404 to close the air inlet 408.

In operation, the linear actuator 416 works in combination with the vacuum generated by the attached air end 228 (shown in FIGS. 2-3) to actuate the check plate 420 between a closed position and an open (or partially open) position. Stated another way, the linear actuator 416 and the air end 228, which is a positive displacement air compressor, are balanced such that the force generated by the combination of the linear actuator and the vacuum are greater (or slightly greater) than the force required to keep the check plate 420 in a closed position (as shown in FIG. 6). The vacuum generated by the air end 228 of the air compressor 200 is capable of overcoming the biasing member 474, allow for movement of the check plate 420 relative to the valve body 404 into a position other than a fully closed position (i.e., any position between the fully closed position, non-inclusive, and a fully position, inclusive, the fully open position being defined by the position of stem 436. Use of the vacuum, or negative pressure, generated by the air end 228 of the air compressor 200 is a unique advantage of the electronic inlet valve 290 over known pneumatic type inlet valves that rely on positive pressure to operate. Without the use of negative pressure, or vacuum generated by the air end 228 of the air compressor 200, the linear actuator would not be physically large enough to move the check plate 420. Stated another way, using negative pressure generated by the air end 228 of the air compressor 200 allows for use of the linear actuator 416 to facilitate movement of the check plate 420 to open, close, and/or otherwise adjust the check plate 420 of the electronic inlet valve 290.

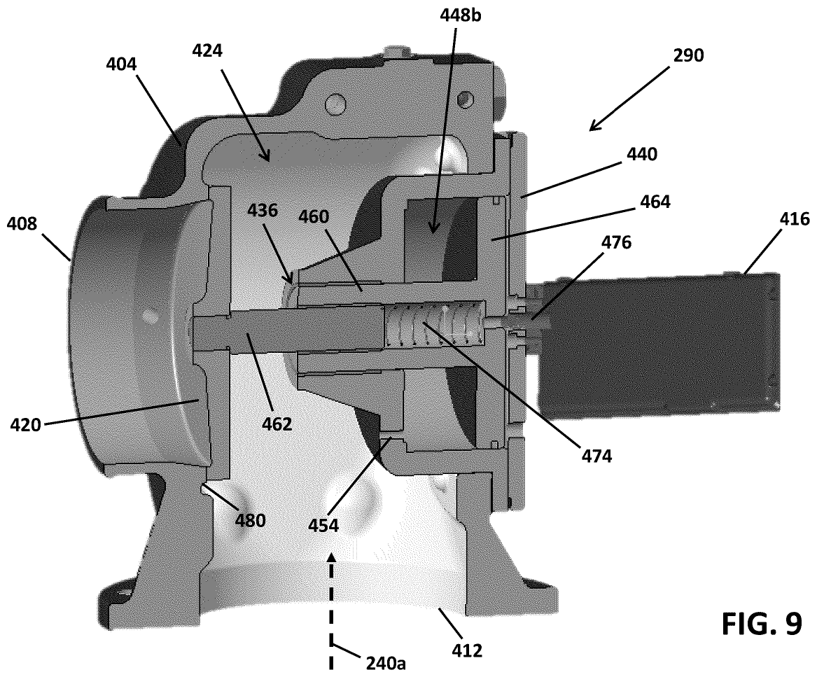

With reference back to FIG. 6, the electronic inlet valve 290 is shown in a first closed configuration (also referred to as a first operational configuration). With reference now to FIG. 9, the first closed configuration can occur during shutdown of the air end 228 of the air compressor 200 (shown in FIGS. 2-3). As the air end 228 shuts down, air no longer travels from the air inlet 408 into the air channel 424, and through the air outlet 412 to supply the air end 228. The air end 228 of the air compressor 200 is not drawing in inlet air 240, and thus no vacuum (or negative air pressure) is present in the air channel 424. With the termination of this air flow 240 (or vacuum), pressure (or back pressure) from the air end 228 (and/or the separator 246) flows backwards into the electronic inlet valve 290. More specifically, back pressure air flow 240a enters the air channel 424 from the air outlet 412. The back pressure air flow 240a passes through the second port 454 (also referred to as the vacuum bleed orifice 454). The back pressure air flow 240a thrusts (or slides) the vacuum balance piston 460 open. More specifically, the back pressure air flow 240a enters the second portion 448b of the chamber 448 (shown in FIG. 8). The back pressure air flow 240a then slides the piston 464 towards the first housing member 440 (or towards the linear actuator 416). The arm 476 of the linear actuator 416 is responsively pushed into a retracted position within the linear actuator 416. In the retracted position, the vacuum balance piston 460 is positioned in the chamber 448 at one end. More specifically, the vacuum balance piston 460 of the valve stem assembly 436 is positioned in the chamber 448 to maximize the second portion 448b of the chamber 448 (shown in FIG. 8) and minimize the first portion 448a of the chamber 448 (also shown in FIG. 8). In the illustrated embodiment, the valve stem assembly 436, and more specifically the piston 464 of the first stem member 460, is positioned at an end of the chamber 448 closest to the linear actuator 416 (or closest to the first housing member 440, or furthest away from the check plate 420).

In addition, the lack of vacuum and associated termination of air flow 240 (shown in FIG. 8) closes the check plate 420. In response to the termination of air flow 240, the biasing force applied by the biasing member 474 is no longer overcome by the vacuum. The biasing member 474 responsively applies a biasing force onto the check plate 420. More specifically, the biasing member 474 applies a biasing force onto the second stem member 462. The second stem member 462 is biased away from the vacuum balance piston 460 (or the first stem member 460). The biasing force applied to the second stem member 462 slides the check plate 420 away from the vacuum balance piston 460. Stated another way, the second stem member 462 slides relative to the first stem member 460 within the channel 468 (shown in FIG. 8) away from the piston 464. The second stem member 462 carries (or pushes) the check plate 420 in response to the biasing force to positions the check plate 420 into engagement with the valve body 404, and more specifically into engagement with the valve seat 480. This results in the electronic inlet valve 290 reaching in the first closed configuration. In the first closed configuration, the check plate 420 is extended from (or spaced from) the vacuum balance piston 460 (or the first stem member 460 of the valve stem assembly 436). The vacuum is configured to overcome the biasing force applied by the biasing member 474, as the vacuum applied to the check plate 420 draws the check plate 420 towards the vacuum balance piston 460. In response to elimination of the vacuum, the biasing force applied by the biasing member 474 pushes the check plate 420 away from the vacuum balance piston 460. The air flow 240 can be referred to as a first air flow 240 or a first air flow direction 240 or a vacuum air flow 240, and the back pressure air flow 240a can be referred to as a second air flow 240a or a second air flow direction 240a.

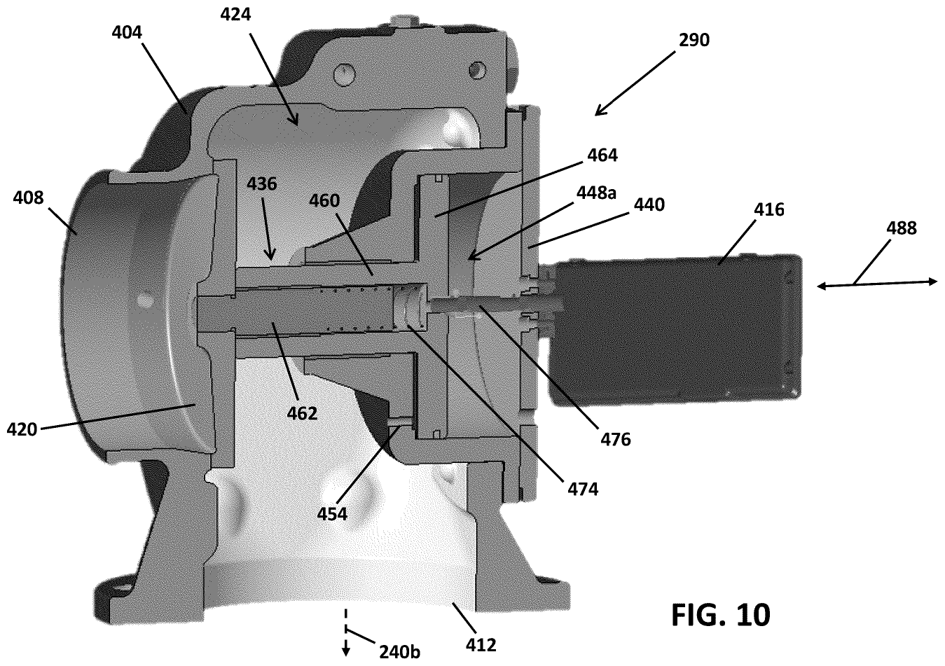

With reference now to FIG. 10, the electronic inlet valve 290 is shown in a second closed configuration (also referred to as a second operational configuration or an unloaded configuration). In this unloaded configuration, the air end 228 of the air compressor 200 (shown in FIGS. 2-3) is not in full operation (i.e., not actively providing service air to a load even though it is still compressing air). As such, the air end 228 still needs to draw at least a small amount of air flow 240b to limit noise and/or vibration occurring in response to the unloaded air end 228. The air flow 240b can also be referred to as anti-rumble flow 240b. The air flow 240b is similar to the air flow 240, except that it has a significantly smaller flow rate. Check 420 is necessarily opened a small amount (through actuation of actuator 416) to facilitate an intake of airflow through the air inlet 408 and provide air flow 240b. During the periods of no air flow (i.e., during engine startup), the check plate 420 remains in a closed position as shown in FIG. 10. Alternatively, a secondary valve (not shown in the FIGs.) can be included to provide a so-called anti-rumble flow when actuated. In such an embodiment, the check plate 420 would remain closed and secondary could provide anti-rumble flow through an alternative path. The secondary valve could be an electrically actuated solenoid or other suitable valves.

In the unloaded configuration, an amount of vacuum (or negative air pressure) is present in the air channel 424. The vacuum is generated by the operation of the air end. The vacuum (or negative air pressure) exits the air channel 424 through the air outlet 412. The vacuum draws air through the second port 454 (or the vacuum bleed orifice 454). The vacuum from the periodic air flow 240b thrusts (or slides) the vacuum balance piston 460 closed. More specifically, the vacuum draws out air from the second portion 448b of the chamber 448 (shown in FIG. 8). The vacuum slides the piston 464 towards the check plate 420 (or away from the first housing member 440 or away from the linear actuator 416). The arm 476 of the linear actuator 416 is responsively positioned into an extended position relative to the linear actuator 416. In the extended position, the vacuum balance piston 460 is positioned in the chamber 448 at one end. More specifically, the vacuum balance piston 460 of the valve stem assembly 436 is positioned in the chamber 448 to maximize the first portion 448a of the chamber 448 (shown in FIG. 8) and minimize the second portion 448b of the chamber 448 (also shown in FIG. 8). In the illustrated embodiment, the valve stem assembly 436, and more specifically the piston 464 of the first stem member 460, is positioned at an end of the chamber 448 closest to the check plate 420 (or furthest away from the linear actuator 416 or furthest away from the first housing member 440).

Concurrently, or in addition, the second stem member 462 slides within the channel 468 (shown in FIG. 8) towards the piston 464. The vacuum, along with the linear actuator 416, is sufficient to slide the check plate 420 into engagement with the vacuum balance piston 460 and compress the biasing member 474. This positions the check plate 420 in the closed position (i.e., positioning the check plate 420 into engagement with the valve body 404, or the valve seat 480 of the valve body 404 (shown in FIG. 7)).

The linear actuator 416 is configured to actuate the valve stem assembly 436 to open the check plate 420 and allow air flow through the air inlet 408 to generate anti-rumble air flow 240b. Stated another way, the linear actuator 416 can actuate the arm 476 to linearly translate along an axis 488. The arm 476 linearly translates towards the linear actuator 416 (or is drawn into the linear actuator 416) along the axis 488. This in turn slides the vacuum balance piston 460 within the chamber 448 (shown in FIG. 8) towards the linear actuator 416 (or towards the first housing member 440). In combination with the vacuum in the air channel 424, the check plate 420 is drawn to an open position, disengaging the valve body 404 (or the valve seat 480 of the valve body 404), allowing air 240b to enter through the air inlet 408, around the check plate 420, into the air channel 424, and through the air outlet 412 to the air end 228.

To close the check plate 420 when the anti-rumble air flow 240b is not needed (e.g., during startup of the engine), the linear actuator 416 can actuate the arm 476 to linearly translate along the axis 488 away from the linear actuator 416 (or is extended away from the linear actuator 416). This in turn slides the vacuum balance piston 460 within the chamber 448 (shown in FIG. 8) away from the linear actuator 416 (or first housing member 440, or towards the check plate 420). In combination with the vacuum in the air channel 424 drawn through the second port 454 (or the vacuum bleed orifice 454), the vacuum balance piston 460 contacts the check plate 420, sliding the check plate 420 into engagement with the valve body 404 (or the valve seat 480 of the valve body 404). In response, this terminates the flow of air 240b through the air inlet 408, closing the valve 290.

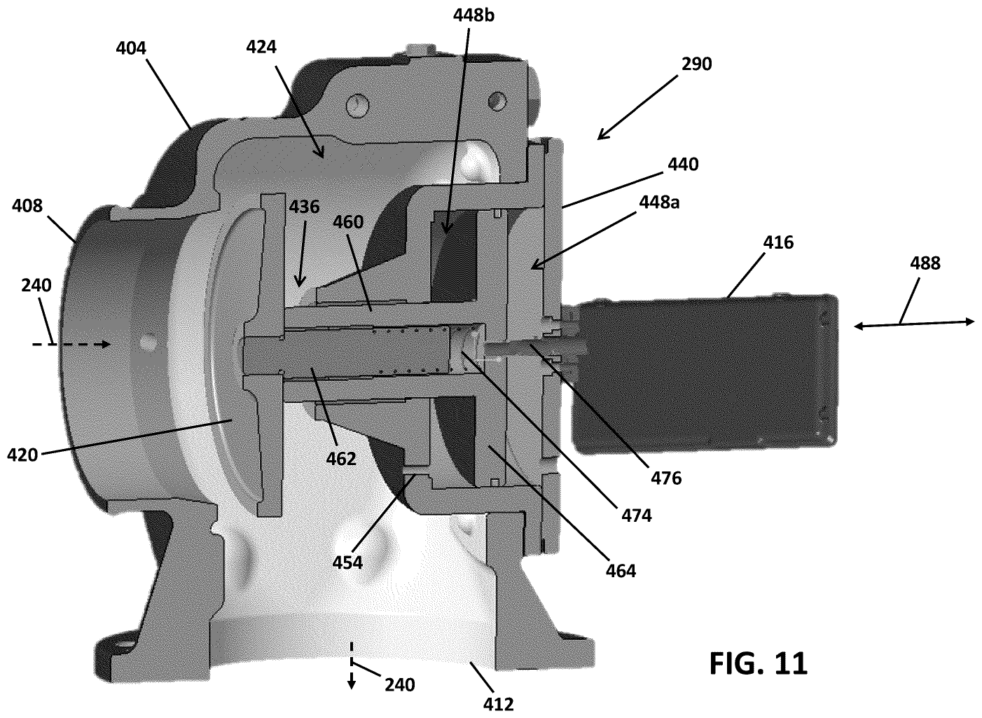

With reference now to FIG. 11, the electronic inlet valve 290 is illustrated in regulated flow configuration (also referred to as a third operational configuration). In this regulated flow configuration, the air end 228 of the air compressor 200 draws in inlet air 240 and the electronic inlet valve 290 controls the flow of inlet air 240 to the air end 228 by positioning the piston 464.

The vacuum, which is the second air source in the illustrated embodiment, is fluidly connected to the second portion 448b of the chamber 448 through the second port 454 (or the vacuum bleed orifice 454). The vacuum of the second air source provides a vacuum assist to the linear actuator 416. Stated another way, the vacuum and the linear actuator 416 work together to control a position of the check plate 420, and in turn regulate the flow of inlet air 240 through the air inlet 408 and into the air channel 424. In this regulated position, the vacuum balance piston 460 is in contact with the check plate 420. The vacuum generated slides the check plate 420 relative to the vacuum balance piston 460. The second stem member 462 slides within the channel 468 (shown in FIG. 8) towards the piston 464. The vacuum overcomes the biasing force applied by the biasing member 474, compressing the biasing member 474. With the biasing force overcome, and the check plate 420 in contact with the vacuum balance piston 460, the linear actuator 416 can control a position of the check plate 420 to regulate air flow 240 by sliding the vacuum balance piston 460.

The linear actuator 416 can include a sensor (not shown) that is configured to determine a position of the check plate 420. For example, the sensor can be position sensor on the linear actuator 416, such as an encoder, Hall effect sensor, or any other suitable sensor for determining a position of the arm 476 of the linear actuator 416. The sensor can be in communication with the control system 300 by the data connection 302 (shown in FIG. 3). For example, the sensor can communicate positional data of the linear actuator 416, such as the position of the arm 476. The control system 300 can receive this data (by the data connection 302) and/or analyze this data to determine an associated valve position (e.g., the position of the check plate 420, etc.). In addition, the control system 300 can provide instructions to the linear actuator 416 to facilitate movement of the arm 476 to achieve a target valve position (e.g., a target position of the check plate 420, etc.).

To decrease a flow of inlet air 240 into the electronic inlet valve 290, the linear actuator 416 facilitates actuation of the arm 476, linearly translating the arm 476 along the axis 488 towards the air inlet 408 (or towards the check plate 420 or away from the linear actuator 416). The valve stem assembly 436 responsively slides (or linearly translates) within the chamber 448, and more specifically the vacuum balance piston 460 slides within the chamber 448. Stated yet another way, the piston 464 slides within the chamber 448. The first stem member 460 and associated piston 464 slide further away from the linear actuator 416 and towards the check plate 420. As the first stem member 460 and associated piston 464 slide further away from the linear actuator 416, the second portion 448b of the chamber 448 becomes smaller in size. In response, the first portion 448a of the chamber 448 becomes larger in size. In response, the check plate 420 moves closer to the air inlet 408 (or towards the valve seat 480). This results in a decrease in the flow of inlet air 240 into the electronic inlet valve 290. It should be appreciated that the minimum open position of the check plate 420 is achieved when the first stem member 460 is positioned within the chamber 448 to a position less than a maximum travel away from the linear actuator 416. In this position, the size of the second portion 448b of the chamber 448 is minimized, while the size of the first portion 448a of the chamber 448 is maximized. Additional movement to a maximum travel away from the linear actuator 416 results in closure of the electronic inlet valve 290, as illustrated in FIG. 10. Subsequent elimination of the vacuum transitions to the shutdown state illustrated in FIG. 9.

To increase a flow of inlet air 240 into the electronic inlet valve 290 (or further open the electronic inlet valve 290), the linear actuator 416 facilitates actuation of the arm 476, linearly translating the arm 476 along the axis 488 away from the air inlet 408 (or away from the check plate 420 or towards the linear actuator 416). The valve stem assembly 436 responsively slides (or linearly translates) within the chamber 448, and more specifically the first stem member 460 slides within the chamber 448. Stated yet another way, the piston 464 slides within the chamber 448. The vacuum balance piston 460460 and associated piston 464 slide towards the linear actuator 416 and further away from the check plate 420. As the first stem member 460 and associated piston 464 slide towards the linear actuator 416, the second portion 448b of the chamber 448 becomes larger in size. In response, the check plate 420 moves away from the air inlet 408 (or away from the valve seat 480). As the check plate 420 moves away from the air inlet 408 (or away from the valve seat 480), the electronic inlet valve 290 opens further to increase the flow of inlet air 240. It should be appreciated that the maximum open position of the check plate 420 is achieved when the first stem member 460 is positioned within the chamber 448 to a position of minimum travel of the arm 476 (or positioned within the chamber 448 closest to the linear actuator 416). In this position, the size of the second portion 448b of the chamber 448 is maximized, while the size of the first portion 448a of the chamber 448 is minimized.

It should also be appreciated that in situations where the vacuum generated by the air flow 240 traveling through the air channel 424 suddenly terminates (e.g., by shutdown of the air end 228) in either a planned or unplanned manner, the electronic inlet valve 290 transitions to a closed position. More specifically, by terminating the vacuum assist, the bias applied to the second stem member 462 by the biasing member 474 is no longer overcome by the vacuum. Accordingly, the bias applied to the second stem member 462 results in the second stem member 462 sliding relative to the first stem member 460, and more specifically away from the first stem member 460. The second stem member 462 carries the check plate 420 into engagement with the valve body 404 (or into engagement with the valve seat 480 shown in FIG. 7), closing the electronic inlet valve 290.

It should be appreciated that the electronic inlet valve 290 described herein can be retrofit into existing air compressors 200. As such, the electronic inlet valve can be provided as an upgrade to existing air compressors 200. The electronic inlet valve 290 can be installed to attach (or fasten) to an air end 228 of an existing air compressor 200, replacing a known inlet valve. The electronic inlet valve 290 can be placed into communication with the control system 300 to facilitate control of the electronic inlet valve 290, including control of the flow of the inlet air 240.

One or more aspects of the electronic inlet valve 290 provides certain advantages. For example, the electronic inlet valve 290 provides improved control than a known valve by utilizing the linear actuator 416 to facilitate movement of the check plate 420. The linear actuator 416 provides improved control of a target flow of inlet air 240. In addition, the linear actuator 416 is sized to operate in combination with the biasing member 474 and/or the vacuum generated by the air end 228 of the air compressor 200. Thus, the pneumatic assist provided by the vacuum allows for use of a smaller sized linear actuator 416 to facilitate movement of the check plate 420 than would otherwise be needed. Further, the electronic inlet valve 290 can be retrofitted to known compressors 200, allowing for improved control of inlet air 240 into an air end 228 in compressors 200 operating in the field. These and other advantages can be realized by the innovation described and claimed herein. Another advantage is that the electronic inlet valve is capable of working in environments where traditional pneumatic lines could be frozen due to the freezing of condensation within the lines in cold weather.

Although the present invention has been described by referring preferred embodiments, workers skilled in the art will recognize that changes may be made in form and detail without departing from the scope of the discussion.

What is claimed is:

1. An air compressor comprising:
a prime mover;
an air end operably connected to the prime mover, the air end configured to compress air; and
an electronic inlet valve operably connected to the air end, the electronic inlet valve including a valve body having an air inlet, a linear actuator coupled to a valve stem assembly, a valve member coupled to the valve stem assembly, a portion of the valve stem assembly is slidably received in a chamber, the chamber includes a first portion in fluid communication with a first fluid and a second portion in fluid communication with a second fluid, wherein the linear actuator is configured to actuate the valve member through the valve stem assembly to control a flow of air to the air end, and wherein the first fluid is at a different pressure than the second fluid.

2. The air compressor of claim 1, wherein the linear actuator is coupled to the valve body.

3. The air compressor of claim 1, further comprising a bonnet assembly coupled to the valve body, the bonnet assembly defining the chamber.

4. The air compressor of claim 3, wherein the bonnet assembly includes a first housing member and a second housing member, the first and second housing members cooperate to define the chamber.

5. The air compressor of claim 1, wherein the valve stem assembly includes a first stem member and a second stem member, the first stem member is coupled to the linear actuator and the second stem member is coupled to the valve member.

6. The air compressor of claim 5, wherein the first stem member defines a channel, and the second stem member is slidably received by the channel.

7. The air compressor of claim 6, wherein the channel includes a biasing member configured to apply a biasing force to the second stem member.

8. The air compressor of claim 5, wherein the first stem member includes a piston configured to slide within the chamber in response to actuation by the linear actuator.

9. The air compressor of claim 8, wherein the piston separates the first portion of the chamber from the second portion of the chamber.

10. The air compressor of claim 1, wherein the second portion of the chamber is in fluid communication with a vacuum generated in the valve body by the air end.

11. The air compressor of claim 1, wherein the first fluid is air at atmospheric pressure and the second fluid is air traveling through the valve body at a vacuum generated by the air end.

12. The air compressor of claim 1, further comprising:
a bonnet assembly coupled to the valve body, the bonnet assembly defining the chamber;
a first port defined by the bonnet assembly, the first port fluidly connecting the first portion of the chamber with the first fluid; and
a second port defined by the bonnet assembly, the second port fluidly connecting the second portion of the chamber with the second fluid.

13. The air compressor of claim 12, wherein the valve body defines an air channel connecting the air inlet to the air end, the second port fluidly connects the second portion of the chamber to the air channel.

14. The air compressor of claim 1, wherein the valve stem assembly includes a first stem member and a second stem member, the second stem member is coupled to the valve member, the first stem member defines a channel, a biasing member is positioned in the channel, wherein the second stem member is slidably received by the channel, and wherein the biasing member is configured to apply a biasing force on the second stem member away from the first stem member.

15. The air compressor of claim 14, wherein the linear actuator is configured to slide the first stem member towards the valve member, and vacuum generated by the air end is configured to slide the second stem member towards the first stem member to overcome the bias applied by the biasing member, responsively moving the valve member to contact the first stem member.

16. An electronic inlet valve comprising:
a valve body defining an air inlet, an air outlet, and an air channel extending between the air inlet and the air outlet;
a valve stem assembly slidably received by the valve body, the valve stem assembly coupled to a check plate, a portion of the valve stem assembly slidably received by a chamber; and
a linear actuator coupled to the valve stem assembly and configured to move the check plate between a first configuration that restricts inlet air through the air inlet and a second configuration that allows inlet air through the air inlet,
wherein the electronic inlet valve is configured to be attached to an air end of an air compressor.

17. The electronic inlet valve of claim 16, further comprising:
a first port configured to fluidly connect a first portion of the chamber to a first fluid source; and
a second port configured to fluidly connect a second portion of the chamber to a second fluid source,
wherein the first fluid source is at a different pressure than the second fluid source.

18. The electronic inlet valve of claim 16, the valve stem assembly further comprising:
a first stem member coupled to the linear actuator, the first stem member defining a channel;
a second stem member coupled to the check plate and slidably received by the channel; and
a biasing member positioned in the channel and configured to apply a biasing force on the second stem member,
wherein in response to a vacuum generated by the air end, the second stem member is configured to slide towards the first stem member to overcome the biasing force, responsively moving the check plate into contact with the first stem member.

19. The electronic inlet valve of claim 18, the first stem member including a piston configured to slide within the chamber, the piston is configured to separate a first portion of the chamber from a second portion of the chamber.

20. The electronic inlet valve of claim 19, further comprising:
a first port configured to fluidly connect the first portion of the chamber to a first fluid source; and
a second port configured to fluidly connect the second portion of the chamber to a second fluid source,
wherein the first fluid source is at a different pressure than the second fluid source.
